(19) United States
(12) Patent Application Publication
(10) Pub. No.: US 2001/0015080 A1
(43) Pub. Date: Aug. 23, 2001

(54) Method and a device for manufacturing preforms for use in making optical fibers

(76) Inventors: Pierre Ripoche, Pithiviers (FR); Alain Drouart, Nanterre (FR); Patrick Humbert, Paris (FR)

Correspondence Address: SUGHRUE, MION, ZINN, MACPEAK & SEAS, PLLC, Suite 800, 2100 Pennsylvania Avenue, N.W., Washington, DC, 20037-3213, US

(21) Appl. No.: 09/725,861

(22) Filed: Nov. 30, 2000

(30) Foreign Application Priority Data
Dec. 30, 1999 (FR) 99 16 718

(51) Int. Cl. C03B 19/01; C03B 19/06

(52) U.S. Cl. 65/391; 65/17.4

(57) ABSTRACT

The invention relates to a method of manufacturing a cylindrical preform for use in making an optical fiber of substantially smaller diameter. The method consists in increasing the diameter of a primary preform by injecting grains onto the surface of the primary preform and in fixing the grains on the surface by means of a heat flow obtained by a plasma torch comprising a tube made of refractory material, and an inductor surrounding the tube. The distance between the inductor and the end of the tube is reduced when the diameter of the preform increases. The temperature of the outside surface is thus increased, thereby enabling preforms to be obtained of larger diameter or with improved efficiency.

The invention relates to a method and to a device for manufacturing a cylindrical glass preform by means of a plasma torch, such a preform being used to make optical fibers.

### BACKGROUND OF THE INVENTION

The use of optical fibers is becoming more and more widespread, in particular in the field of telecommunications.

That increase in use has led to an increase in production and thus to the need to increase the productivity of manufacturing installations.

That problem exists both for the manufacture of fibers proper and for the manufacture of intermediate products used in their manufacture. To manufacture an optical fiber having a diameter of 125 microns, a glass preform having a diameter of approximately 40 mm to 80 mm is used, and the preform itself is made from a primary preform having a diameter of approximately 20 mm to 25 mm, the diameter of the primary preform being progressively increased by depositing silica.

The invention relates to manufacturing such a preform from a primary preform. It relates more particularly to manufacturing a preform using a plasma torch.

A plasma torch comprises a tube made of refractory material, e.g. silica, into which heating gas is injected, in particular air, which gas is directed radially towards the primary preform. To form a plasma, the injected air is brought to a very high temperature of about 10000° C. to 15000° C. by means of an inductor constituted by a coil of conductive material surrounding a portion of the outside surface of the tube made of refractory material; the coil is fed with high frequency AC at several MHz, and with high power of about 50 kW to 150 kW. The air heated in this way serves to deposit the silica progressively on the outside surface of the primary preform. To this end, grains of silica are injected into the gap between the outlet end of the torch and the outside surface of the preform during manufacture.

To deposit the silica evenly on the outside surface of the primary preform, said primary preform is turned about its longitudinal axis and it is displaced back and forth along the direction of its longitudinal axis in front of the plasma torch at a constant distance from said torch. In this way, a preform is obtained that is of good quality, i.e. homogenous, transparent, and without gas bubbles.

In order to obtain a preform that is satisfactorily homogenous, it is necessary for its outside surface to remain at a high temperature (greater than 2000° C.) during manufacture. Unfortunately, for determined power and for determined flowrate of plasma air, the deposition temperature, which is proportional to the temperature of the plasma coming into contact with the outside surface of the preform, depends on the distance from said surface to the center of the inductor. It is also preferable to maintain the distance between the torch outlet and the outside surface of the preform constant so as to maintain a good flow of plasma gas and good injection of the grains at the torch outlet. To achieve this object the axis of the preform during manufacture must not remain at a constant distance from the inductor, since that would lead to a progressive reduction in the distance between the outside surface of the preform and the outlet end of the torch, and thus to disturbance in the flow of plasma gas and in the injection of the grains. The distance between the torch outlet and the outside surface of the preform is thus maintained constant by moving the axis of the preform away from the plasma torch as the diameter of the primary preform increases.

FIG. 1 is a diagram showing the conventional method of manufacturing a preform by means of a plasma torch. The diagram shows, firstly, the primary preform 10 before any deposition on its outside surface and, secondly, the preform 12 at the end of manufacture having a perimeter that is significantly greater. The distance d between the end 14 of the refractory tube 16 and the preform generator line 18 that is closest to the end 14 remains constant.

Arrow f shows the displacement of the axis 20, 20′ of the preform during manufacture.

It should be noted that the end 14 of the tube 16 of the torch is at a distance D from the inductor 22 which is long enough to prevent electric arcs from being produced between the inductor and the plasma leaving via the end 14.

The tube 16 has a double wall (not shown in detail) in which cooling water circulates.

The device shown in FIG. 1 is used to make preforms of a given diameter, and if it is desired to make preforms of greater diameter (e.g. to change from 100 mm to 150 mm), it is necessary to increase the power supplied to the inductor in such a manner as to increase the power, i.e. the temperature of the outside surface of the preform for larger diameters. In addition, if it is desired to increase production capacity, it is necessary to increase the flowrate of silica grains leaving an injector 24 between the end 14 and the outside surface of the preform. Increasing the flowrate of grains also leads to the need to increase the power.

However, the power supplied to the inductor cannot exceed limits determined by the ability of the tube 16 made of refractory material to withstand high temperatures.

### OBJECTS AND SUMMARY OF THE INVENTION

The invention enables the preform production capacity of an installation to be increased without it being necessary to increase the power supplied to the inductor.

In the invention, in order to increase the temperature of the outside surface for larger diameters, the end of the torch is moved closer to the inductor so as to reduce the distance between the inductor and the outside surface of the preform.

In the preferred embodiment of the invention, the distance between the end of the torch and the outside surface of the preform is maintained substantially constant during manufacture so as to maintain a suitable flow of plasma gas and a satisfactory injection of grains. In other words, if the inductor is stationary, the distance between the inductor and the outside surface varies. It is greater for smaller preform diameters than it is for larger preform diameters. This condition is favorable to manufacture of good quality since the power supplied increases with the diameter.

To prevent the production of electric arcs which could result from a reduction in the distance between the inductor and the end of the torch, an insulating screen is provided at the end of the torch, said screen separating the inductor from the plasma leaving the torch.

The invention makes it possible to manufacture preforms of larger diameter; and/or to obtain higher productivity; and/or to obtain preforms of improved quality. Gains of speed and efficiency of about 25% can thus be obtained.

The present invention provides a method of manufacturing a cylindrical preform for use in making an optical fiber of substantially smaller diameter, the method consisting in increasing the diameter of a primary preform by injecting grains onto the surface of the primary preform and in fixing the grains on the surface by means of a heat flow obtained by a plasma torch comprising a tube made of refractory material, and an inductor surrounding the tube. The distance between the inductor and the end of the tube is reduced when the diameter of the preform increases.

In an implementation, the axis of the preform is moved away from the inductor, which remains fixed, when the diameter of the preform increases.

In an implementation, the distance between the end of the tube of the plasma torch and the outside surface of the preform is maintained substantially constant when the diameter of the preform increases.

The present invention also provides a device for implementing the method, the device comprising means for displacing the tube of the torch along its axis, relative to the fixed inductor.

In an embodiment, the device includes an insulating screen separating the inductor from the gap in which the plasma is formed.

In an embodiment, the device includes an injector for projecting grains which is movable with the tube of the plasma torch.

### BRIEF DESCRIPTION OF THE DRAWING

Other characteristics and advantages of the invention appear with the description of some of its embodiments, the description being given with reference to the accompanying drawing in which:

FIG. 1, already described, is a diagram of a known device; and

FIG. 2 is a diagram similar to that of FIG. 1 showing a device of the invention.

### MORE DETAILED DESCRIPTION

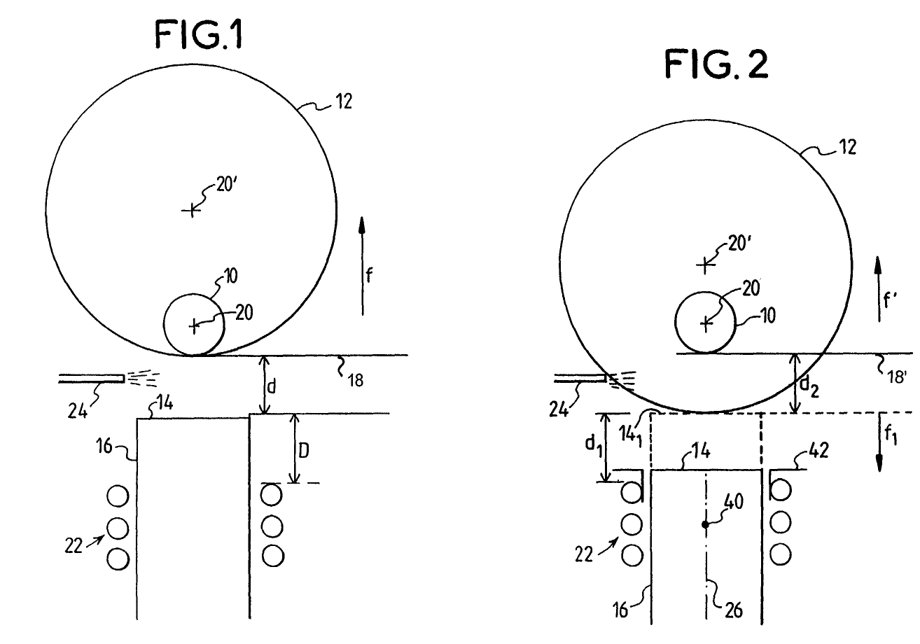

In FIG. 2, the elements similar to those in FIG. 1 have the same reference numerals.

In the embodiment shown in FIG. 2, the inductor 22 is stationary, i.e. cannot move. In contrast, the torch 16 is displaceable along its axis 26. The longitudinal axis 20, 20′ of the preform 10, 12 is displaceable transversely along the direction of the axis 26 as the diameter of the preform increases.

Thus, at the start of manufacture, when the primary preform 10 is installed, the end 141 of the torch, as shown by dashed lines, is at a distance d₁ from the portion of the inductor 22 which faces said end, and said end 14₁ is at a distance d₂ from the generator line 18′ closest to the primary preform 10. The injector 24 projects silica grains into the gap between the end 14₁ and the primary preform 10.

When the diameter of the preform 10 increases, the distance between the end 14₁ of the torch 16 and the generator line closest to the preform is kept substantially constant, and the distance separating the end from the inductor is reduced.

In other words, in contrast to the torch shown in FIG. 1 where only one displacement f is performed, specifically by the axis of the preform, in the embodiment shown in FIG. 2, the preform is displaced (arrow f′) in one direction, and the torch 16 in the opposite direction, along arrow f₁.

The support of the injector 24 is secured to the moving support of the torch, the injector support thus moving with the tube 16 so that the silica grains are injected effectively when the torch is displaced along arrow f₁.

The position of the torch when the preform 12 has reached its largest diameter is shown by a solid line. In this case, it can be seen that the distance between the inductor 22 and the outside surface (which in the particular case of FIG. 2 is d₁) is shorter than the corresponding distance at the start of manufacture (which in the particular case of FIG. 2 is d₁+d₂). In other words, for larger diameters, the temperature of the plasma surface in contact with the preform, and thus the temperature of the outside surface of the preform are both higher, thereby contributing to obtaining a preform having uniform characteristics.

Compared with the structure shown in FIG. 1, the distance between the core 40 of the plasma at the center of the inductor and the outside surface of the preform is reduced for larger diameters, thereby leading to a useful power gain and thus to the possibility of increasing productivity, and/or of increasing the diameter of a preform, and/or of increasing its quality.

To prevent electric arcs from forming when the torch is in the position shown by a solid line (end near to the inductor), a screen 42 is disposed in the vicinity of the inductor at its end facing the outlet 14 of the torch 16.

In the example, the insulating screen 42 is constituted by a quartz collar having a thickness of about 2 mm.

The invention make it possible, in particular, for existing installations to increase productivity without said installations needing to be greatly modified.

1. A method of manufacturing a cylindrical preform for use in making an optical fiber of substantially smaller diameter, the method consisting in increasing the diameter of a primary preform by injecting grains onto the surface of the primary preform and in fixing the grains on the surface by means of a heat flow obtained by a plasma torch comprising a tube made of refractory material, and an inductor surrounding the tube, wherein the distance between the inductor and the end of the tube is reduced when the diameter of the preform increases.

2. A method according to claim 1, wherein the axis of the preform is moved away from the inductor, which remains fixed, when the diameter of the preform increases.

3. A method according to claim 1, wherein the distance between the end of the tube of the plasma torch and the outside surface of the preform is maintained substantially constant when the diameter of the preform increases.

4. A device for implementing the method according to claim 1, the device comprising means for displacing the tube of the torch along its axis, relative to the fixed inductor.

5. A device according to claim 4, including an insulating screen separating the inductor from the gap in which the plasma is formed.

6. A device according to claim 4, including an injector for projecting grains which is movable with the tube of the plasma torch.
